(19) United States
(12) Patent Application Publication
(10) Pub. No.: US 2026/0066789 A1
(43) Pub. Date: Mar. 5, 2026

(54) Multi-phase Converter Circuit

(71) Applicant: Richtek Technology Corporation, Zhubei City (TW)

(72) Inventors: Kuo-Chi Liu, Hsinchu (TW); Ta-Yung Yang, Taoyuan (TW)

(21) Appl. No.: 19/182,737

(22) Filed: Apr. 18, 2025

Related U.S. Application Data
(60) Provisional application No. 63/687,869, filed on Aug. 28, 2024.

(30) Foreign Application Priority Data
Jan. 24, 2025 (TW) 114103423

(51) Int. Cl. H02M 3/158; H02M 1/00; H02M 1/38; H02M 1/44; H02M 3/07

(52) U.S. Cl. CPC H02M 3/158; H02M 1/0009; H02M 1/0058; H02M 1/385; H02M 1/44; H02M 3/07

(57) ABSTRACT

The present invention discloses a multi-phase converter circuit, which includes at least one two-phase converter circuit coupled between a first voltage and a second voltage, and employs switching control of at least one capacitor and at least one coupled inductor, with alternated charging phase and discharging phase, to achieve power conversion between the first voltage and the second voltage.

### CROSS REFERENCE

The present invention claims priority to provisional application 63/687,869 filed on Aug. 28, 2024, and TW 114103423 filed on Jan. 24, 2025.

### BACKGROUND OF THE INVENTION

### Field of Invention

The present invention relates to a multi-phase converter circuit, and more particularly to a multi-phase converter circuit exhibiting improved electromagnetic interference (EMI) mitigation performance.

### Description of Related Art

High performance and high power density are essential in many applications, such as data centers, servers, electric vehicles, and mobile devices. Recently, many systems have adopted a 48V bus voltage to increase the maximum power capability, such as the 48V bus voltage used in data centers, automotive systems, and USB PD EPR systems. Accordingly, a high voltage conversion ratio, high efficiency, and miniaturization have become critical requirements.

FIG. 1 shows a conventional dual-phase buck converter. This prior art configuration uses two buck converters connected in parallel to increase the output current. However, in high-voltage applications as described above, this prior art requires high-voltage-tolerant switching components to withstand the peak input voltage. In addition, due to the higher voltage across the inductors, the required inductance value must also be increased.

The present invention provides a multi-phase converter circuit, wherein the multi-phase converter circuit operates in either a resonant mode or a regulation mode. Compared to conventional multi-phase buck converter circuits, the present invention offers several advantages, including higher power efficiency, reduced inductor size, lower component voltage stress, and higher power density.

### SUMMARY OF THE INVENTION

From one perspective, the present invention provides a multi-phase converter circuit comprising at least one two-phase converter circuit configured to perform power conversion between a first voltage and a second voltage. Each of the at least one two-phase converter circuits includes: a first conversion terminal and a second conversion terminal; a plurality of switches; a first conversion capacitor; and a coupled inductor comprising a first inductor and a second inductor, the first inductor and the second inductor being inversely coupled, and the coupled inductor having an equivalent leakage inductor; wherein the plurality of switches control electrical connection relationships among the first conversion capacitor, the first inductor, the second inductor, the first voltage, and the second voltage, so as to form a plurality of electrical connection states, such that the first conversion capacitor alternately switches between a charging phase having a charging time and a discharging phase having a discharging time; wherein, in the charging phase, the plurality of switches control the first conversion capacitor and the first inductor to be electrically connected in series between the first conversion terminal and the second conversion terminal, such that a first inductor current is generated flowing through the first inductor, and a second inductor current is induced flowing through the second inductor through magnetic coupling; wherein, in the discharging phase, the plurality of switches control the first conversion capacitor and the second inductor to be electrically connected in series between a ground potential and the second conversion terminal, such that the second inductor current is generated flowing through the second inductor, and the first inductor current is induced flowing through the first inductor through magnetic coupling; wherein the at least one two-phase converter circuit includes a first two-phase converter circuit having the first conversion terminal coupled to the first voltage and the second conversion terminal coupled to the second voltage.

In one preferred embodiment, the charging time and the discharging time respectively correspond to half of a resonant period determined by the first conversion capacitor and the leakage inductor of the coupled inductor, so as to control the first conversion capacitor and the coupled inductor to perform a resonant operation for power conversion.

In one preferred embodiment, each of the at least one two-phase converter circuits comprises: a first high-side switch coupled between the first conversion terminal and a first shunting node; the first conversion capacitor coupled between the first shunting node and a first switching node; a first low-side switch coupled between the first switching node and the ground potential; the first inductor coupled between the first switching node and the second conversion terminal; a second high-side switch coupled between the first shunting node and a second switching node; a second low-side switch coupled between the second switching node and the ground potential; and the second inductor coupled between the second switching node and the second conversion terminal; wherein, in the charging phase, the first high-side switch is turned ON to control the first conversion capacitor and the first inductor to be electrically connected in series between the first and second conversion terminals; wherein, in the discharging phase, the first low-side switch and the second high-side switch are turned ON to control the first conversion capacitor and the second inductor to be electrically connected in series between the ground potential and the second conversion terminal.

In one preferred embodiment, the at least one two-phase converter circuit comprises sequentially arranged first to Qth two-phase converter circuits, wherein Q is greater than 1. Each of the first to Qth two-phase converter circuits has a first conversion terminal coupled to the first voltage, and has the second conversion terminal coupled to the second voltage. Corresponding switches of any two adjacent two-phase converter circuits are configured to switch in opposite phase with each other.

In one preferred embodiment, each of the at least one two-phase converter circuits further comprises an auxiliary switched-capacitor converter circuit comprising an auxiliary capacitor, a first auxiliary switch, and a second auxiliary switch. The first auxiliary switch is coupled between the first conversion terminal and an auxiliary shunting node, the second auxiliary switch is coupled between the auxiliary shunting node and the first switching node, and the auxiliary capacitor is coupled between the auxiliary shunting node and the second switching node; wherein, in the charging phase, the second auxiliary switch is turned ON to control the auxiliary capacitor and the first inductor to be electrically connected in series between the ground potential and the second conversion terminal, and to control the first conversion capacitor and the first inductor to be electrically connected in series between the first and second conversion terminals, while the second inductor is electrically connected between the ground potential and the second conversion terminal; wherein, in the discharging phase, the first auxiliary switch is turned ON to control the auxiliary capacitor and the second inductor to be electrically connected in series between the first and second conversion terminals, and to control the first conversion capacitor and the second inductor to be electrically connected in series between the ground potential and the second conversion terminal, and to control the first inductor to be electrically connected in series between the ground potential and the first conversion terminal.

In one preferred embodiment, the at least one two-phase converter circuit comprises sequentially arranged first to Mth two-phase converter circuits, wherein M is greater than or equal to 2. The first conversion terminal of the kth two-phase converter circuit is coupled to a second shunting node of the (k−1)th two-phase converter circuit, and the second conversion terminal of the kth two-phase converter circuit is coupled to the second voltage, where k=2 to M. Each of the first to (M−1)th two-phase converter circuits further comprises a second conversion capacitor coupled between the second high-side switch and the second switching node, wherein the second high-side switch and the second conversion capacitor are jointly coupled to the corresponding second shunting node. The switches of the first to Mth two-phase converter circuits are configured to switch in phase with each other.

In one preferred embodiment, a capacitance of the second conversion capacitor is significantly larger than a capacitance of the first conversion capacitor, such that only the first conversion capacitor and either the first inductor or the second inductor participate in the resonant operation.

In one preferred embodiment, the multi-phase converter circuit further comprises an auxiliary switched-inductor converter circuit, which includes an auxiliary high-side switch, an auxiliary low-side switch, and an auxiliary inductor. The auxiliary high-side switch is coupled between a second shunting node of the Mth two-phase converter circuit and an auxiliary switching node. The auxiliary low-side switch is coupled between the auxiliary switching node and the ground potential, and the auxiliary inductor is coupled between the auxiliary switching node and the second voltage. The auxiliary high-side switch is turned ON during the charging phase to control the auxiliary inductor to be electrically connected between the second shunting node of the Mth two-phase converter circuit and the second voltage, thereby generating an auxiliary inductor current.

In one preferred embodiment, the first two-phase converter circuit further comprises a second conversion capacitor coupled between the second high-side switch and the second switching node, the second high-side switch and the second conversion capacitor being jointly coupled to a second shunting node. The multi-phase converter circuit further comprises an auxiliary switched-inductor converter circuit, which includes an auxiliary high-side switch, an auxiliary low-side switch, and an auxiliary inductor. The auxiliary high-side switch is coupled between the second shunting node of the first two-phase converter circuit and an auxiliary switching node. The auxiliary low-side switch is coupled between the auxiliary switching node and the ground potential, and the auxiliary inductor is coupled between the auxiliary switching node and the second voltage. The auxiliary high-side switch is turned ON during the charging phase to control the auxiliary inductor to be electrically connected between the second shunting node of the first two-phase converter circuit and the second voltage, thereby generating an auxiliary inductor current.

In one preferred embodiment, the first inductor and the second inductor have the same number of turns.

In one preferred embodiment, the plurality of the electrical connection states further optionally includes a freewheeling phase, in which the plurality of switches control the first inductor and the second inductor to be electrically connected between the ground potential and the second conversion terminal for demagnetization.

In one preferred embodiment, during the charging phase, when the first inductor current flowing through the first inductor decreases a predetermined below zero-current threshold, the operation transitions to the discharging phase; or, during the discharging phase, when the second inductor current flowing through the second inductor decreases below the predetermined zero-current threshold, the operation transitions to the charging phase, thereby achieving zero-current switching (ZCS) or zero-voltage switching (ZVS).

In one preferred embodiment, at a timing when the charging phase transitions to the discharging phase, the first inductor current is greater than the second inductor current, and a difference between the first inductor current and the second inductor current corresponds to a magnetizing current; and at a timing when the discharging phase transitions to the charging phase, the second inductor current is greater than the first inductor current, and a difference between the second inductor current and the first inductor current corresponds to the magnetizing current.

In one preferred embodiment, a dead time is provided when switching between the charging and discharging phases. During the dead time, the magnetizing current is used to achieve zero-voltage switching of the first high-side switch and/or the second high-side switch.

In one preferred embodiment, at a steady state, a DC component of the voltage across the first conversion capacitor of each of the first to Qth two-phase converter circuits is 1/N of the first voltage, and a voltage conversion ratio between the first voltage and the second voltage is 2N:1, wherein N is a positive integer greater than or equal to 2.

In one preferred embodiment, at a steady state, a DC component of a voltage across the first conversion capacitor of each of the first to k′th two-phase converter circuits is (2M−(2k′−1))/2M of the first voltage, and a DC component of a voltage across the second conversion capacitor of each of the first to k′th two-phase converter circuits is (2M−2k)/2M of the first voltage, wherein k′=1˜M, and a voltage conversion ratio between the first voltage and the second voltage is 2M·2:1.

In one preferred embodiment, at a steady state, a DC component of a voltage across the first conversion capacitor of each of the first to k′th two-phase converter circuits is ((2M+1)−(2k′−1))/(2M+1) of the first voltage, and a DC component of a voltage across the second conversion capacitor of each of the first to k′th two-phase converter circuits is ((2M+1)−2k′)/(2M+1) of the first voltage, wherein k′=1˜M, and a voltage conversion ratio between the first voltage and the second voltage is (2M+1)·2:1.

In one preferred embodiment, a ratio between the second voltage and the first voltage is adjusted by controlling a duty cycle and/or a switching frequency of the charging phase and/or the discharging phase.

In one preferred embodiment, the two-phase converter circuit comprises a first current sensing circuit and a second current sensing circuit, which are respectively coupled in parallel to the first inductor and second inductor to generate respectively a first current sensing signal and a second current sensing signal, respectively indicating the first inductor current and the second inductor current. The first and second current sensing circuits respectively comprise a sensing resistor and a sensing capacitor.

In one preferred embodiment, during the resonant operation, the first conversion capacitor undergoes net charging during the charging phase and net discharging during the discharging phase.

The objectives, technical details, features, and effects of the present invention will be better understood with regard to the detailed description of the embodiments below, with reference to the attached drawings.

### BRIEF DESCRIPTION OF THE DRAWINGS

FIG. 1 is a circuit schematic diagram of a two-phase buck converter circuit of a prior art.

FIG. 2 is a circuit schematic diagram of a multi-phase converter circuit according to one embodiment of the present invention.

FIG. 3 is a circuit schematic diagram of a multi-phase converter circuit according to one embodiment of the present invention.

FIGS. 4, 5 and 6 illustrate schematic diagrams of several electrical connection states of the embodiment of the multi-phase converter circuit shown in FIG. 3.

FIG. 7 illustrates a small-signal circuit model corresponding to Switching State 1 in FIG. 4.

FIG. 8 illustrates a small-signal circuit model corresponding to Switching State 2 in FIG. 5.

FIG. 9 is a waveform diagram showing the operating signals corresponding to the multi-phase converter circuit of FIG. 3, according to a preferred embodiment of the present invention.

FIG. 10 illustrates the flow direction of the magnetizing current during the time interval t1 to t2 corresponding to FIG. 9.

FIG. 11 illustrates the flow direction of the magnetizing current during the time interval t3 to t4 corresponding to FIG. 9.

FIG. 12 is a circuit schematic diagram of a current sensing circuit in the multi-phase converter circuit according to a specific embodiment of the present invention.

FIG. 13 is a circuit schematic diagram of a multi-phase converter circuit according to one embodiment of the present invention.

FIG. 14 is a circuit schematic diagram of a multi-phase converter circuit according to an extended embodiment of the present invention.

FIG. 15 is a circuit schematic diagram of a multi-phase converter circuit with a voltage conversion ratio of 6:1, according to one embodiment of the present invention.

FIG. 16 is a circuit schematic diagram of a multi-phase converter circuit with a voltage conversion ratio of 8:1, according to another embodiment of the present invention.

FIG. 17 is a circuit schematic diagram of a multi-phase converter circuit with a voltage conversion ratio of 10:1, according to yet another embodiment of the present invention.

FIG. 18 is a circuit schematic diagram of a multi-phase converter circuit with a voltage conversion ratio of 12:1, according to a further embodiment of the present invention.

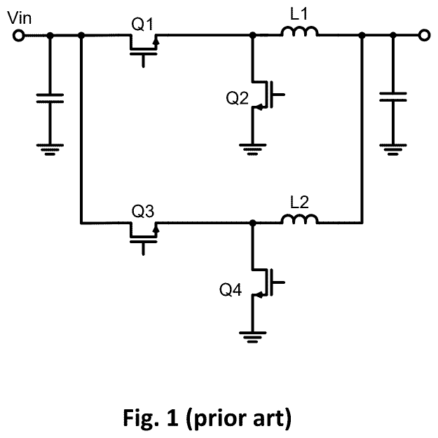

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

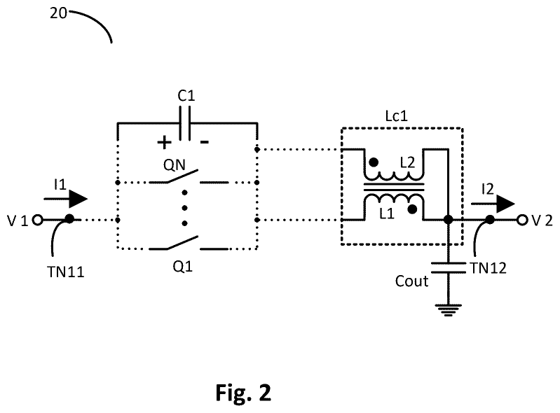

FIG. 2 illustrates an embodiment of the multi-phase converter circuit according to the present invention, which is configured to convert a first voltage V1 into a second voltage V2, or convert the second voltage V2 to the first voltage V1. In the following description, most embodiments are described with the first voltage V1 as the input voltage and the second voltage V2 as the output voltage. However, in other embodiments, the first voltage V1 may serve as the output voltage and the second voltage V2 as the input voltage.

A converter circuit 20 includes at least one conversion capacitor (e.g., C1), at least one coupled inductor (e.g., Lc1), and a plurality of switches (e.g., Q1 to QN, where N is greater than 2). The coupled inductor Lc1 includes a first inductor L1 and a second inductor L2, which are reversely coupled. The first inductor L1 and the second inductor L2, together with an output capacitor Cout, are jointly coupled to the output voltage V2. The plural switches (Q1 to QN) control the electrical connection relationships among the first conversion capacitor C1, the first inductor L1, the second inductor L2, the first voltage V1, and the second voltage V2, so as to form a plural electrical connection states. Consequently, the first conversion capacitor C1 alternately switches between a charging phase having a charging time and a discharging phase having a discharging time, thereby achieving voltage conversion between the first voltage V1 and the second voltage V2. In one embodiment, the first inductor L1 and the second inductor L2 are both coupled to the second voltage V2, thereby further doubling the voltage conversion ratio.

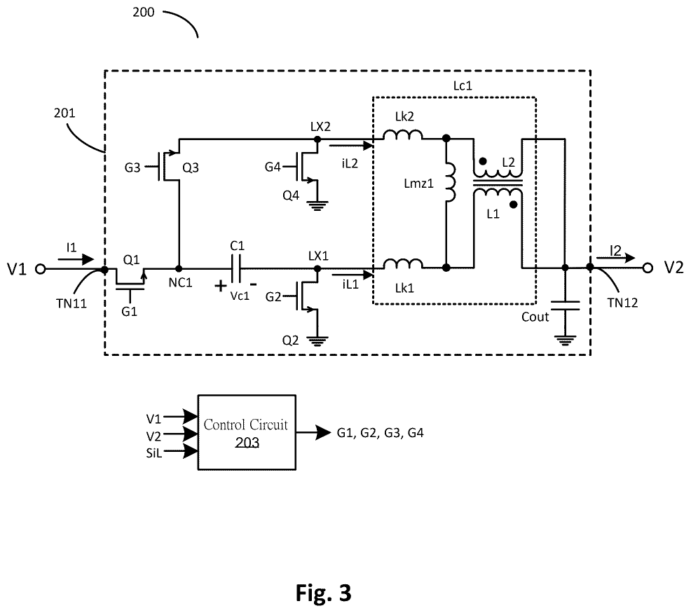

FIG. 3 illustrates a specific embodiment of a multi-phase converter circuit according to the present invention. A multi-phase converter circuit 200 includes a two-phase converter circuit 201. The conversion terminals TN11 and TN12 of the two-phase converter circuit 201 are respectively coupled to the first voltage V1 and the second voltage V2. The two-phase converter circuit 201 includes a first conversion capacitor C1, a coupled inductor Lc1, and four switches (Q1 to Q4). The four switches (Q1 to Q4) respectively correspond to a first high-side switch Q1, a first low-side switch Q2, a second high-side switch Q3, and a second low-side switch Q4 of the two-phase converter circuit 201. The first high-side switch Q1 is coupled between the conversion terminal TN11 and a first shunting node NC1. The first conversion capacitor C1 is coupled between the first shunting node NC1 and a first switching node LX1. The first inductor L1 is coupled between the first switching node LX1 and the conversion terminal TN12. The first low-side switch Q2 is coupled between the first switching node LX1 and a ground potential. The second high-side switch Q3 is coupled between the first shunting node NC1 and a second switching node LX2. The second inductor L2 is coupled between the second switching node LX2 and the conversion terminal TN12. The second low-side switch Q4 is coupled between the second switching node LX2 and the ground potential.

A control circuit 203 provides switching control signals G1 to G4, which are used to control the switching operations of the switches (Q1 to Q4) to perform power conversion between the first voltage V1 and the second voltage V2.

The multi-phase converter circuit can operate in a resonant mode to achieve high-performance operation, or it can operate in a regulation mode to adjust the output voltage. In one embodiment, the multi-phase converter circuit 200 senses the inductor currents iL1 and iL2. When the inductor current iL1 or iL2 falls below a zero-current threshold, the Switching States of the switches (Q1 to Q4) are changed, thereby enabling resonant-mode operation. Consequently, zero-voltage switching (ZVS) and zero-current switching (ZCS) are achieved for enhanced performance. In the resonant mode, the charging time and the discharging time respectively correspond to half of the resonant period determined by the first conversion capacitor C1 and the leakage inductor Lk1 or Lk2 of the coupled inductor Lc1, thereby controlling the resonant operation of the first conversion capacitor C1 and the coupled inductor Lc1 for power conversion between the first voltage V1 and the second voltage V2.

On the other hand, during regulation mode operation, the multi-phase converter circuit 200 adjusts the duty cycles and switching frequency of the control signals G1 to G4 (e.g., higher or lower than the resonant frequency of the multi-phase converter circuit 200), so as to regulate the output voltage to a predetermined level or within a preset range.

Furthermore, FIG. 3 also shows a circuit model of the coupled inductor Lc1. The leakage inductors Lk1 and Lk2 respectively represent the leakage inductors of the first inductor L1 and the second inductor L2, and Lmz represents the equivalent magnetizing inductor of the coupled inductor Lc1. In one embodiment, the first inductor L1 and the second inductor L2 are inversely coupled and have the same number of turns (N1:N2=1:1), such that the coupled inductor Lc1 may be modeled as an ideal transformer, wherein N1 and N2 respectively denote the number of turns of the first inductor L1 and the second inductor L2.

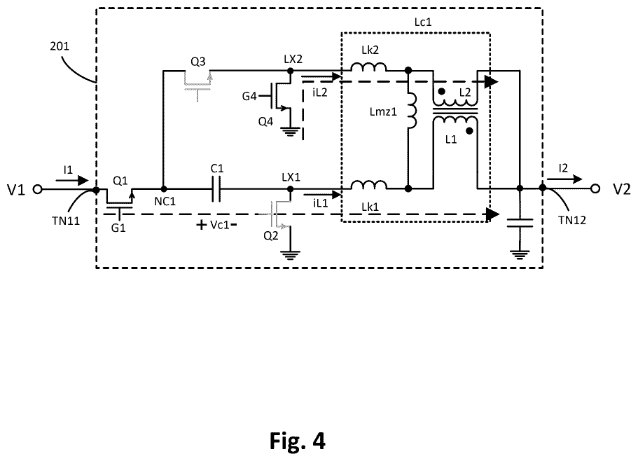

Referring also to FIGS. 4 to 6, FIGS. 4 to 6 illustrate schematic diagrams of several electrical connection states of the embodiment of the multi-phase converter circuit shown in FIG. 3, with the first voltage V1 being described as the input voltage and the second voltage V2 as the output voltage. In the Switching State 1 shown in FIG. 4, the first high-side switch Q1 and the second low-side switch Q4 are turned ON, while the first low-side switch Q2 and the second high-side switch Q3 are turned OFF. The conversion capacitor C1 is charged by the input voltage (V1), and the first inductor L1 is magnetized via the conversion capacitor C1 by a voltage difference between the voltage at the switching node LX1 (i.e., V1−Vc1) and the output voltage (V2), such that inductor currents iL1 and iL2 are generated, and a magnetizing current iLmz is established. Here, Vc1 denotes the voltage across the first conversion capacitor C1. The output current equals the sum of the inductor currents (I2=iL1+iL2). In one embodiment, during Switching State 1, the second low-side switch Q4 may alternatively remain turned OFF and conduct via its body diode.

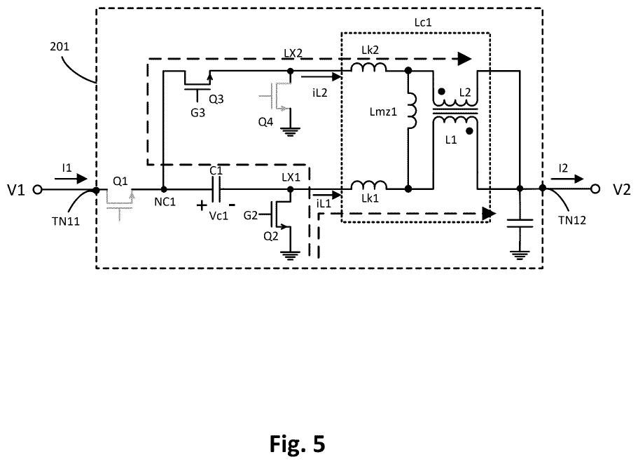

In Switching State 2, as illustrated in FIG. 5, the first low-side switch Q2 and the second high-side switch Q3 are turned ON, while the first high-side switch Q1 and the second low-side switch Q4 are turned OFF. The first conversion capacitor C1 discharges, and the inductor L2 is magnetized by the voltage of the conversion capacitor C1 (Vc1), generating the inductor currents iL1 and iL2 and the magnetizing current iLmz. In one embodiment, in Switching State 2, the first low-side switch Q2 may remain OFF, and its body diode may conduct instead.

For the first conversion capacitor C1, in the previously described Switching State 1, the first conversion capacitor C1 undergoes net charging, while in Switching State 2, the first conversion capacitor C1 undergoes net discharging. Therefore, Switching State 1 and Switching State 2 can be respectively referred to as the charging phase and the discharging phase.

Through the above configuration and periodic switching operations, at steady state, a DC component of the voltage across the first conversion capacitor C1 is V1·1/2. Additionally, due to the further voltage division by the two branches of the coupled inductor Lc1, the voltage conversion ratio between the input voltage (V1) and the output voltage (V2) reaches 4:1. The two-phase converter circuit 201 enhances the upper limit of the output current I2 while reducing the ripple of the input current I1.

Since the voltage stress across switches (Q1−Q4) is reduced to half of the input voltage (V1·1/2), lower-voltage-rated switches can be used in the multi-phase converter circuit 200, thereby reducing conduction resistance and cost. Furthermore, the voltage across the coupled inductor is reduced to (V1·1/2−V2), and the current flowing through each inductor is half of the output current (1/2·I2). As a result, the coupled inductor Lc1 can be implemented using a smaller, lower-inductance, lower-impedance, and lower-power-loss inductor.

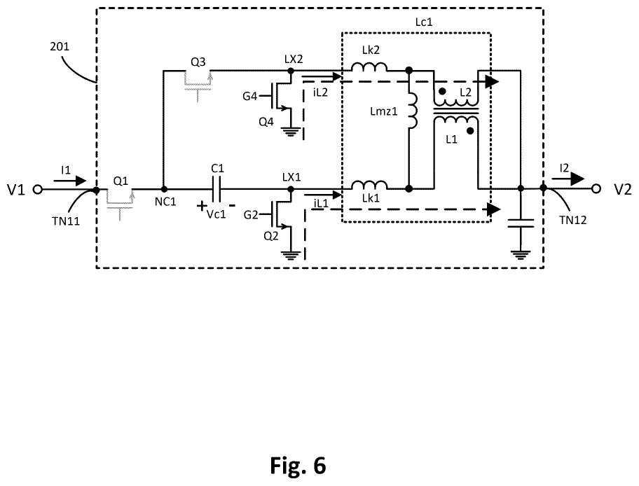

In Switching State 3, as illustrated in FIG. 6, the first low-side switch Q2 and the second low-side switch Q4 are turned ON, while the first high-side switch Q1 and the second high-side switch Q3 are turned OFF. The first inductor L1 and the second inductor L2 undergo demagnetization, and the inductor currents (iL1 and iL2) flow from the ground potential toward the output voltage (V2). In one embodiment, by periodically operating in Switching State 3 with an appropriate duty cycle, regulation mode operation can be achieved.

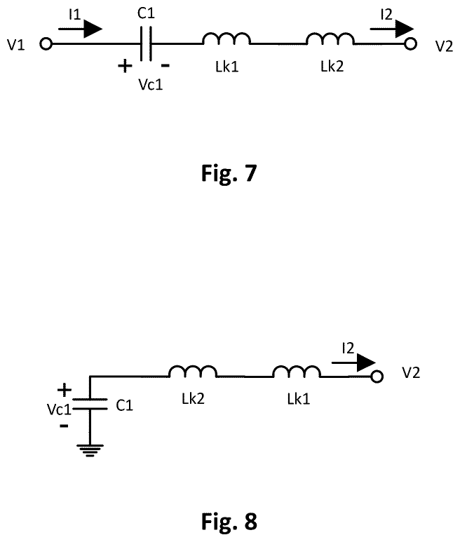

FIG. 7 illustrates a small-signal circuit model corresponding to Switching State 1 shown in FIG. 4. When Lmz is significantly larger than Lk1 and Lk2, the equivalent leakage inductor of the coupled inductor is equal to the series combination of Lk1 and Lk2. Under this condition, C1, Lk1, and Lk2 are connected in series between the input voltage (V1) and the output voltage (V2). The resonant frequency fres of the multi-phase convertor circuit can be estimated using the following formula:

$${f}_{res} = \frac{1}{2 π \sqrt{C 1 \times ( Lk 1 + Lk 2 )}}$$

FIG. 8 illustrates a small-signal circuit model corresponding to Switching State 2 shown in FIG. 5. When Lmz is significantly larger than Lk1 and Lk2, C1, Lk1, and Lk2 are connected in series between the ground potential and the output voltage V2. The resonant frequency in Switching State 2 is identical to that of the circuit model shown in FIG. 7.

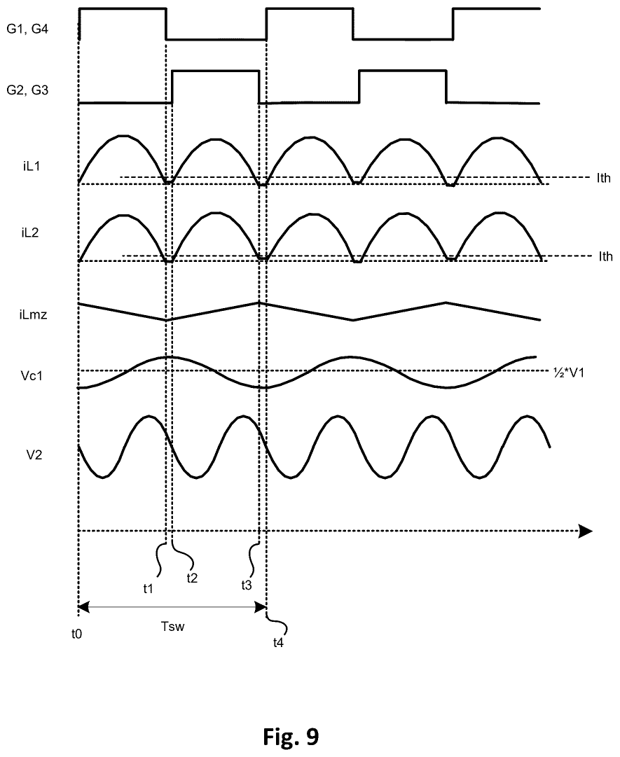

FIG. 9 illustrates a waveform diagram corresponding to a preferred embodiment of the multi-phase converter circuit shown in FIG. 3. This embodiment of the multi-phase converter circuit operates with two primary Switching States: Switching State 1 and Switching State 2. The switching control signals G1 and G4 respectively control switches Q1 and Q4, while switching control signals G2 and G3 respectively control switches Q2 and Q3. The switching control signals G1 and G4 are in-phase, while the switching control signals G2 and G3 are out-of-phase with G1 and G4.

During the time period from to to t1, the multi-phase converter circuit is in Switching State 1, where the first high-side switch Q1 and the second low-side switch Q4 are turned ON, and the first low-side switch Q2 and the second high-side switch Q3 are turned OFF. When the inductor currents (iL2/iL1) drop below the predetermined zero-current threshold Ith, the switching control signals G1 and G4 are disabled (e.g., set to a low level), thereby turning OFF first high-side switch Q1 and the second low-side switch Q4. The predetermined zero-current threshold Ith is a current threshold close to zero.

During the time period from t2 to t3, the multi-phase converter circuit is in Switching State 2, where the first high-side switch Q1 and the second low-side switch Q4 are turned OFF, and the first low-side switch Q2 and the second high-side switch Q3 are turned ON. When the inductor currents (iL2/iL1) drop below the predetermined zero-current threshold Ith, the switching control signals G2 and G3 are disabled, thereby turning OFF the first low-side switch Q2 and the second high-side switch Q3.

Additionally, the time period from t1 to t2 and t3 to t4 correspond to dead-time periods between Switching State 1 and Switching State 2. It is worth noting that in this embodiment, during the period t1 to t2, the inductor current iL1 is slightly higher than the inductor current iL2, whereas during the period t3 to t4, the inductor current iL2 is slightly higher than the inductor current iL1. From another perspective, the difference between inductor currents iL2 and iL1, as shown in FIG. 9, corresponds to the magnetizing current iLmz. Furthermore, in this embodiment, the multi-phase converter circuit operates in a resonant mode, where the switching period Tsw shown in FIG. 9 corresponds to the resonant period, and the switching period of inductor currents iL2 and iL1 is Tsw·1/2.

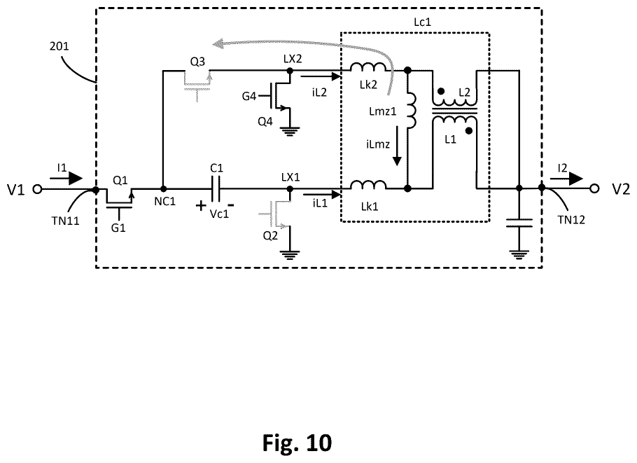

FIG. 10 illustrates the magnetizing current flow direction during the time period from t1 to t2 corresponding to FIG. 9. When the first high-side switch Q1 and the second low-side switch Q4 turn OFF, the magnetizing current iLmz flows to the second high-side switch Q3 (as indicated by the gray arrow), thereby discharging the parasitic capacitance of the second high-side switch Q3 and achieving zero-voltage switching (ZVS) for the second high-side switch Q3.

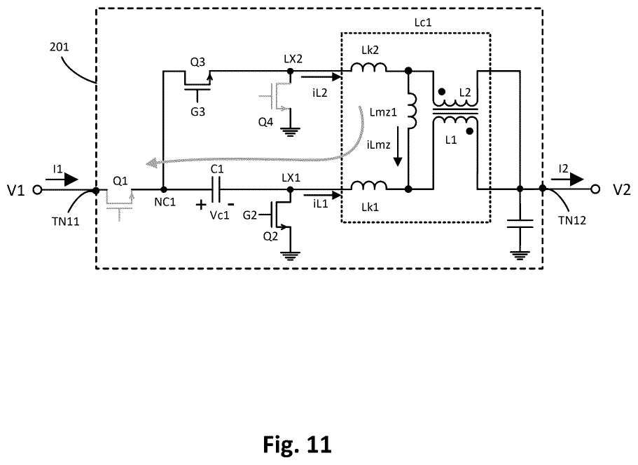

FIG. 11 illustrates the magnetizing current flow direction during the time period from t3 to t4 corresponding to FIG. 9. When the first low-side switch Q2 and the second high-side switch Q3 turn OFF, the magnetizing current iLmz flows to the first high-side switch Q1 (as indicated by the gray arrow), thereby discharging the parasitic capacitance of the first high-side switch Q1 and achieving zero-voltage switching (ZVS) for the first high-side switch Q1.

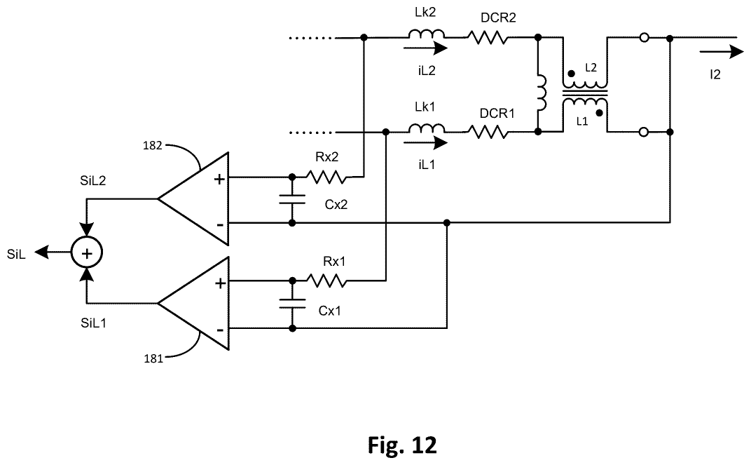

FIG. 12 illustrates a specific embodiment of a current sensing circuit in the multi-phase converter circuit according to the present invention, used for generating a current sensing signal from the coupled inductor. The first inductor L1 and the second inductor L2 respectively include parasitic DC resistances DCR1 and DCR2. The first current sensing circuit includes a sensing resistor Rx1 and a sensing capacitor Cx1; the second current sensing circuit includes a sensing resistor Rx2 and a sensing capacitor Cx2. The sensing resistor Rx1 and the sensing capacitor Cx1 are connected in series, and this series branch is coupled to the first inductor L1 (including DCR1) in parallel. Similarly, the sensing resistor Rx2 and the sensing capacitor Cx2 are connected in series, and this series branch is coupled to inductor L2 (including DCR2) in parallel. When the time constant (L1, DCR1) matches (Rx1, Cx1), the voltage across the sensing capacitor Cx1 can be used to sense the inductor current iL1. Here, L1 and DCR1 respectively represent the inductance value and resistance value of the first inductor L1, while Rx1 and Cx1 respectively represent the resistance value of sensing resistor Rx1 and the capacitance value of sensing capacitor Cx1. The same principle applies to inductor L2. Amplifiers 181 and 182 are used to amplify the voltages across sensing capacitors Cx1 and Cx2 to generate current sensing signals SiL1 and SiL2, respectively. The total current sensing signal SiL is the sum of all inductor current signals (e.g., SiL1 and SiL2).

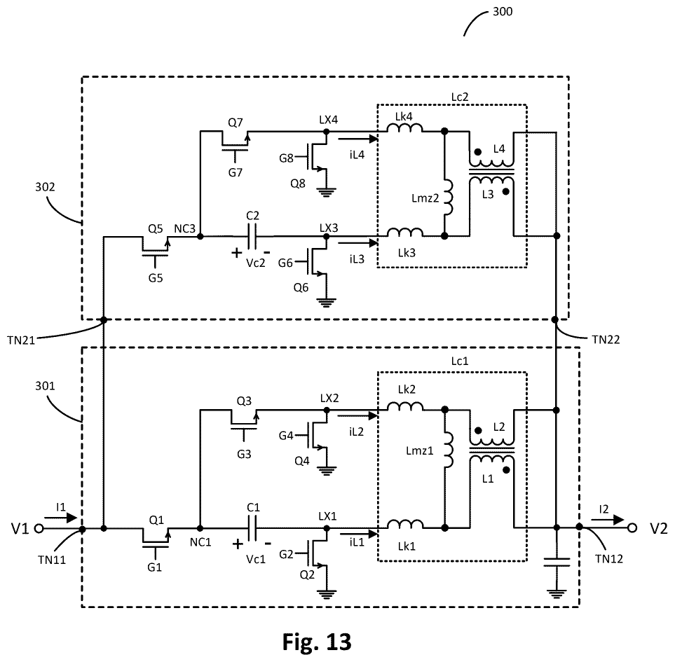

FIG. 13 illustrates one embodiment of the multi-phase converter circuit of the present invention. A multi-phase converter circuit 300 includes two parallel-operating 4:1 two-phase converter circuits 301 and 302, wherein each of the two-phase converter circuits 301 and 302 may correspond, for example, to the two-phase converter circuit 201 shown in FIG. 3. In one embodiment, the two two-phase converter circuits 301 and 302 operate in a resonant mode to achieve soft switching with zero-current switching (ZCS) and zero-voltage switching (ZVS). In one embodiment, the two two-phase sub-converter circuits 301 and 302 switch in an interleaved manner. For example, the switching timing of the first high-side switch Q5 is phase-shifted by 180 degrees with respect to the switching timing of the first high-side switch Q1, thereby further reducing the ripple of the input current. The two branches of the coupled inductor Lc1 and the two branches of the coupled inductor Lc2 are all connected to the output voltage V2 to provide a high output current I2. In other embodiments, the number of parallel two-phase converter circuits may be extended to more phases. In one embodiment, the corresponding switches in any two adjacent two-phase converter circuits are controlled to switch in reversed phases.

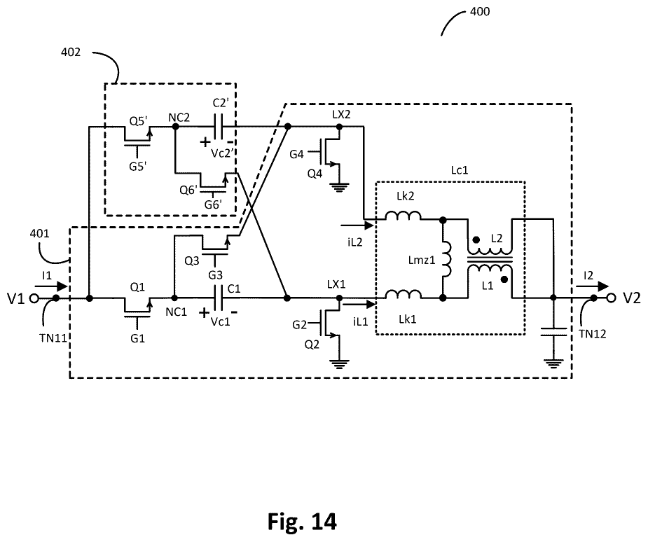

FIG. 14 illustrates an extended embodiment of the multi-phase converter circuit according to the present invention. The multi-phase converter circuit 400 includes a two-phase converter circuit 401 and a switched-capacitor converter circuit 402. The two-phase converter circuit 401 may correspond to the two-phase converter circuit 201 shown in FIG. 3. In this embodiment, the switched-capacitor converter circuit 402 is added to the architecture shown in FIG. 3, and cooperatively operates with the two-phase converter circuit 401 to further reduce the ripple of the input current I1. The switched-capacitor converter circuit 402 includes an auxiliary capacitor C2′, a first auxiliary switch Q5′, and a second auxiliary switch Q6′. As shown in FIG. 14, the first auxiliary switch Q5′ is coupled between the first conversion terminal TN11 and an auxiliary shunting node NC2′. The second auxiliary switch Q6′ is coupled between the auxiliary shunting node NC2′ and the first switching node LX1. The auxiliary capacitor C2′ is coupled between the auxiliary shunting node NC2′ and the second switching node LX2.

In this embodiment, in Switching State 1 (charging phase), the first high-side switch Q1, the second low-side switch Q4, and the second auxiliary switch Q6′ are turned ON, thereby controlling the auxiliary capacitor C2′ and the first inductor L1 to be series-connected between the ground potential and the second conversion terminal TN12, controlling the first conversion capacitor C1 and the first inductor L1 to be series-connected between the first conversion terminal TN11 and the second conversion terminal TN12, and controlling the second inductor L2 to be connected between the ground potential and the second conversion terminal TN12. In Switching State 2 (discharging phase), the first low-side switch Q2, the second high-side switch Q3, and the first auxiliary switch Q5′ are turned ON, thereby controlling the auxiliary capacitor C2′ and the second inductor L2 to be series-connected between the first conversion terminal TN11 and the second conversion terminal TN12, controlling the first conversion capacitor C1 and the second inductor L2 to be series-connected between the ground potential and the second conversion terminal TN12, and controlling the first inductor L1 to be series-connected between the ground potential and the first conversion terminal TN11.

From one perspective, the multi-phase converter circuit 400 shown in FIG. 14 can be regarded as a two-phase converter circuit in which the two capacitors C1 and C2′ and the coupled inductor Lc1 are switched in a cross-coupled manner. This embodiment can further reduce the ripple of the input current.

In one embodiment, when the inductance of the magnetizing inductance Lmz is significantly greater than those of the leakage inductors Lk1 and Lk2, the resonant frequency fres of the converter circuit can be estimated by the following equation:

$${f}_{res} = \frac{1}{2 π \sqrt{( C 1 + C2 ) \times ( Lk 1 + Lk 2 )}}$$

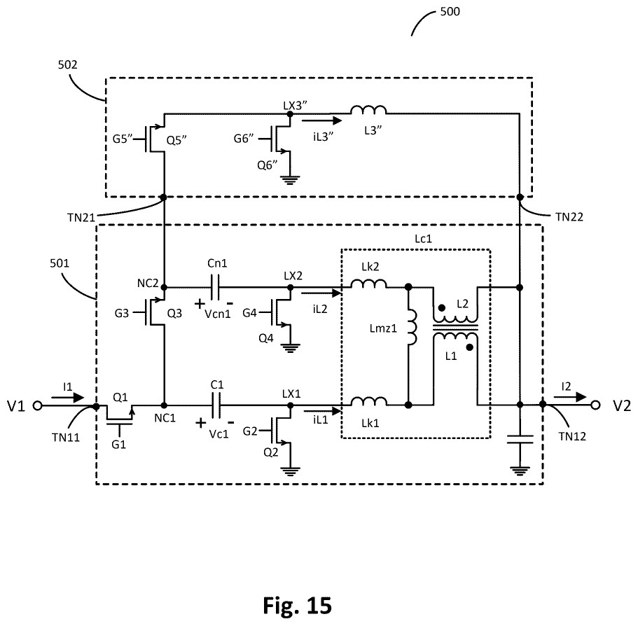

FIG. 15 illustrates an embodiment of a multi-phase converter circuit having a voltage conversion ratio of 6:1 in accordance with the present invention. The multi-phase converter circuit 500 includes a two-phase converter circuit 501 and a switched-inductor converter circuit 502. The two-phase converter circuit 501 is similar to the two-phase converter circuit 201 shown in FIG. 3. In this embodiment, the two-phase converter circuit 501 further includes a second conversion capacitor Cn1, which is coupled between the second high-side switch Q3 and the second switching node LX2. The second high-side switch Q3 and the second conversion capacitor Cn1 are coupled to a second shunting node NC2.

The switched-inductor converter circuit 502 includes an auxiliary high-side switch Q5″, an auxiliary low-side switch Q6″, and an auxiliary inductor L3″. The auxiliary high-side switch Q5″ is coupled between the second shunting node NC2 of the two-phase converter circuit 501 and an auxiliary switching node LX3″. The auxiliary low-side switch Q6″ is coupled between the auxiliary switching node LX3″ and the ground potential. The auxiliary inductor L3″ is coupled between the auxiliary switching node LX3″ and the second voltage V2.

In Switching State 1, the auxiliary high-side switch Q5″ is turned ON and the auxiliary low-side switch Q6″ is turned OFF, thereby controlling the auxiliary inductor L3″ to be electrically connected between the second shunting node NC2 of the two-phase converter circuit 501 and the second voltage V2, so as to generate an auxiliary inductor current iL3 through the auxiliary inductor L3″. On the other hand, in Switching State 2, the auxiliary low-side switch Q6″ is turned ON and the auxiliary high-side switch Q5″ is turned OFF, thereby controlling the auxiliary inductor L3″ to be electrically connected between the ground potential and the second voltage V2. The multi-phase converter circuit 500 of the present embodiment achieves a voltage conversion ratio of 6:1 through the coordinated switching operation of the switched-inductor converter circuit 502 and the two-phase converter circuit 501. In steady state, the DC component of the voltage across the first conversion capacitor C1 is V1·2/3, and that of the second conversion capacitor Cn1 is V1·1/3.

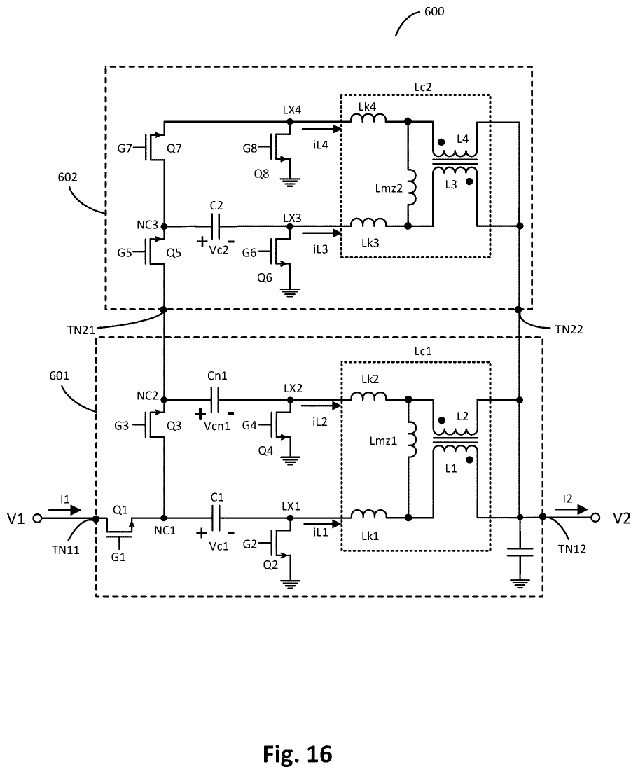

FIG. 16 illustrates an embodiment of a multi-phase converter circuit having a voltage conversion ratio of 8:1 in accordance with the present invention. The multi-phase converter circuit 600 includes two two-phase converter circuits 601 and 602, each having corresponding first and second conversion terminals. Specifically, the two-phase converter circuit 601 includes first and second conversion terminals TN11 and TN12, and the two-phase converter circuit 602 includes first and second conversion terminals TN21 and TN22. The two-phase converter circuit 601 may correspond to the two-phase converter circuit 501 shown in FIG. 15, and the two-phase converter circuit 602 may correspond to the two-phase converter circuit 201 shown in FIG. 3. In this embodiment, the first and second conversion terminals TN11 and TN12 of the two-phase converter circuit 601 are respectively coupled to the first voltage V1 and the second voltage V2, and the first and second conversion terminals TN21 and TN22 of the two-phase converter circuit 602 are respectively coupled to the second shunting node NC2 of the two-phase converter circuit 601 and the second voltage V2.

In one embodiment, the multi-phase converter circuit 600 also includes two main Switching States, which correspond to Switching State 1 and Switching State 2 in the embodiment shown in FIG. 3. In Switching State 1, the high-side switches Q1 and Q5 and the low-side switches Q4 and Q8 are turned ON, while the low-side switches Q2 and Q6 and the high-side switches Q3 and Q7 are turned OFF. In Switching State 2, the high-side switches Q1 and 05 and the low-side switches Q4 and Q8 are turned OFF, while the low-side switches Q2 and Q6 and the high-side switches Q3 and Q7 are turned ON. Specifically, in Switching State 1, the first conversion capacitors C1 and C2 are charged by the input voltage V1 and the voltage of the second conversion capacitor Cn1, respectively. The inductors L1 and L3 are excited by the voltage differences between (V1−Vc1) and (Vcn1−Vc2) and the output voltage V2 via the first switching nodes LX1 and LX3, respectively, to generate the inductor currents iL1, iL2, iL3, and iL4, as well as the magnetizing currents iLmz1 and iLmz3, where Vcn1 is the voltage across the second conversion capacitor Cn1, and Vc2 is the voltage across the first conversion capacitor C2. The output current I2 is equal to the sum of the inductor currents (I2=iL1+iL2+iL3+iL4).

Through the above configuration and periodic switching operation, in a steady state, the DC components of the voltages across the first conversion capacitors C1 and C2 are respectively V1·3/4 and V1·1/4, while the DC component of the voltage across the second conversion capacitor Cn1 is V1·2/4. Furthermore, due to the further voltage division provided by the two branches of the coupled inductors Lc1 and Lc2, a voltage conversion ratio of 8:1 between the input voltage V1 and the output voltage V2 is achieved. Additionally, since the multi-phase converter circuit 600 includes two two-phase converter circuits, it functions as a 4-phase converter circuit, thereby further increasing the upper limit of the output current I2 and reducing the ripple of the input current I1.

In one embodiment, the multi-phase converter circuit 600 operates in a resonant mode to achieve zero current switching (ZCS) and zero voltage switching (ZVS). When the capacitance of the second conversion capacitor Cn1 is significantly greater than that of the first conversion capacitor C1 (e.g., Cn1>10×C1), the second conversion capacitor Cn1 functions as a non-resonant capacitor—i.e., it does not participate in the resonant operation. The first resonant frequency of the two-phase converter circuit 601 is determined by the capacitance of the first conversion capacitor C1 and the inductances of leakage inductors Lk1 and Lk2 of the coupled inductor Lc1. Similarly, the second resonant frequency of the two-phase converter circuit 602 is determined by the capacitance of the first conversion capacitor C2 and the leakage inductances Lk3 and Lk4 of the coupled inductor Lc2. In a preferred embodiment, the first and second resonant frequencies can be configured to be equal.

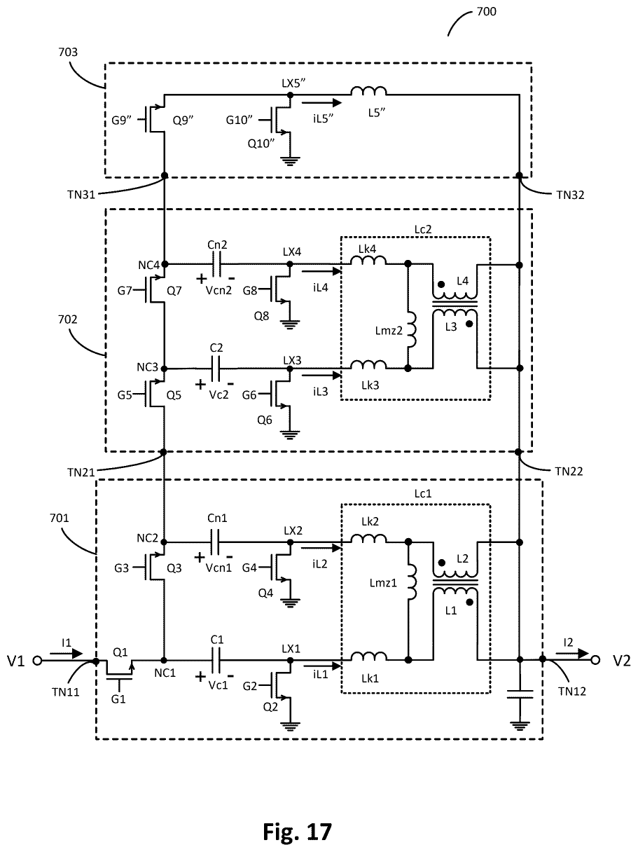

FIG. 17 illustrates an embodiment of a multi-phase converter circuit having a voltage conversion ratio of 10:1 according to the present invention. The multi-phase converter circuit 700 includes two two-phase converter circuits 701 and 702, and a switched-inductor converter circuit 703. This embodiment can be regarded as an extension of the embodiment shown in FIG. 16, with the addition of a switched-inductor converter circuit as illustrated in FIG. 15. The two-phase converter circuits 701 and 702 may correspond respectively to the two-phase converter circuits 601 and 602 of FIG. 16, and the switched-inductor converter circuit 703 may correspond to the switched-inductor converter circuit 502 of FIG. 15. The two-phase converter circuit 702 further includes a second conversion capacitor Cn2. The switched-inductor converter circuit 703 is coupled between the second shunting node NC4 of the two-phase converter circuit 702 and the second voltage V2. The remaining operational details may be inferred from FIGS. 6 and 16 and are omitted here for brevity.

Through the above configuration and periodic switching operation, in a steady state, the DC components of the voltages across the first conversion capacitors C1 and C2 are respectively V1·4/5 and V1·2/5, while the DC components of the voltages across the second conversion capacitors Cn1 and Cn2 are respectively V1·3/5 and V1·1/5. Furthermore, due to the additional voltage division provided by the coupled inductors Lc1 and Lc2, a voltage conversion ratio of 10:1 between the input voltage V1 and the output voltage V2 is achieved. Since the multi-phase converter circuit 700 includes two two-phase converter circuits and one switched-inductor converter circuit, it functions as a 5-phase converter circuit, which can further increase the upper limit of the output current I2 and reduce the ripple of the input current I1.

In one embodiment, the multi-phase converter circuit 700 operates in a resonant mode to achieve ZCS and ZVS. When the capacitances of the second conversion capacitors Cn1 and Cn2 are each significantly greater than those of their respective first conversion capacitors C1 and C2, the second conversion capacitors function as non-resonant capacitors. Under such conditions, the resonant frequencies of the two-phase converter circuits 701 and 702 are determined respectively by the capacitances of the first conversion capacitors C1 and C2 and the corresponding leakage inductances.

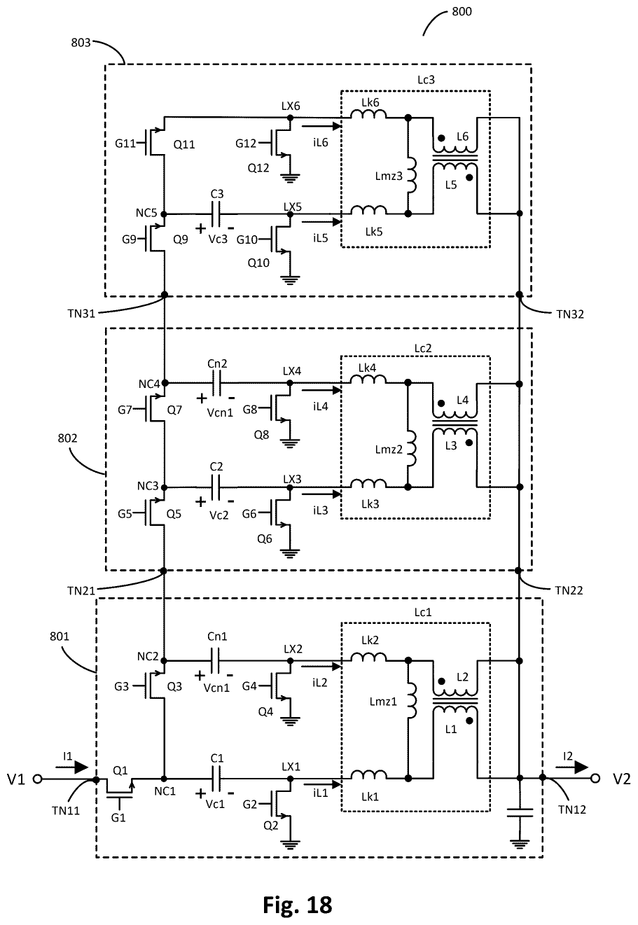

FIG. 18 illustrates an embodiment of a multi-phase converter circuit having a voltage conversion ratio of 12:1 according to the present invention. The multi-phase converter circuit 800 includes three two-phase converter circuits 801, 802, and 803. This embodiment may be viewed as an extension of the embodiment shown in FIG. 16. The two-phase converter circuits 801 and 802 may correspond to the two-phase converter circuit 601 in FIG. 16, and the two-phase converter circuit 803 may correspond to the two-phase converter circuit 602 in FIG. 16. The two-phase converter circuit 802 further includes a second conversion capacitor Cn2. In this embodiment, the first and second conversion terminals TN11 and TN12 of the two-phase converter circuit 801 are coupled to the first voltage V1 and the second voltage V2, respectively. The first and second conversion terminals TN21 and TN22 of the two-phase converter circuit 802 are coupled to the second shunting node NC2 of the two-phase converter circuit 801 and the second voltage V2, respectively. The first and second conversion terminals TN31 and TN32 of the two-phase converter circuit 803 are coupled to the second shunting node NC4 of the same circuit and the second voltage V2. Other operational details may be inferred from FIGS. 15 and 16 and are omitted here for brevity.

With the above configuration and periodic switching operation, in steady state, the DC components of the voltages across the first conversion capacitors C1, C2, and C3 are respectively V1·5/6, V1·3/6, and V1·3/6, and the DC components of the voltages across the second conversion capacitors Cn1 and Cn2 are respectively V1·4/6 and V1·2/6. The additional voltage division provided by the coupled inductors enables the achievement of a voltage conversion ratio of 12:1 between the input voltage V1 and the output voltage V2. Other characteristics may be inferred from the aforementioned embodiments.

Moreover, depending on various application requirements, the configuration and operating principles of the aforementioned embodiments may be extended to form multi-phase converter circuits with higher even or odd phase counts. For instance, the multi-phase converter circuit illustrated in FIG. 17 can be extended to include three or more two-phase converter circuits along with one switched-inductor converter circuit. Similarly, the multi-phase converter circuit in FIG. 18 can be extended to include four or more two-phase converter circuits.

In an embodiment comprising M two-phase converter circuits (e.g., FIG. 16 or FIG. 18), in steady state, the DC component of the voltage across the first conversion capacitor of the kth two-phase converter circuit is (2M−(2k−1))/2M of the first voltage V1, and the DC component of the voltage across the second conversion capacitor is (2M−2k)/2M of the first voltage V1. The voltage conversion ratio between the first voltage V1 and the second voltage V2 is 2M·2:1, where k=1 to M, and M is an integer greater than or equal to 2.

On the other hand, in an embodiment comprising M′ two-phase converter circuits and additionally including one switched-inductor converter circuit (e.g., FIG. 15 or FIG. 17), in steady state, the DC component of the voltage across the first conversion capacitor of the k′th two-phase converter circuit is ((2M′+1)−(2k′−1))/(2M′+1) of the first voltage V1, and that of the second conversion capacitor is ((2M′+1)−2k′)/(2M′+1) of the first voltage V1. The voltage conversion ratio between the first voltage V1 and the second voltage V2 is (2M′+1)·2:1, where k′=1 to M′, and M′ is an integer greater than or equal to 1.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A multi-phase converter circuit, comprising at least one two-phase converter circuit configured to perform power conversion between a first voltage and a second voltage, wherein each of the at least one two-phase converter circuits comprises:
a first conversion terminal and a second conversion terminal;
a plurality of switches;
a first conversion capacitor; and
a coupled inductor, including a first inductor and a second inductor, wherein the first inductor and the second inductor are reversely coupled, and the coupled inductor has an equivalent leakage inductor;
wherein the plurality of switches control electrical connection relationships among the first conversion capacitor, the first inductor, the second inductor, the first voltage, and the second voltage, to form a plurality of electrical connection states, such that the first conversion capacitor alternately switches between a charging phase having a charging time and a discharging phase having a discharging time;
wherein, in the charging phase, the plurality of switches control the first conversion capacitor and the first inductor to be electrically connected in series between the first conversion terminal and the second conversion terminal, such that a first inductor current is generated flowing through the first inductor, and a second inductor current is induced flowing through the second inductor via electromagnetic coupling;
wherein, in the discharging phase, the plurality of switches control the first conversion capacitor and the second inductor to be electrically connected in series between a ground potential and the second conversion terminal, such that the second inductor current is generated flowing through the second inductor, and the first inductor current is induced flowing through the first inductor via electromagnetic coupling;
wherein the at least one two-phase converter circuit includes a first two-phase converter circuit, in which the first conversion terminal is coupled to the first voltage, and the second conversion terminal is coupled to the second voltage.

2. The multi-phase converter circuit of claim 1, wherein the charging time and the discharging time respectively correspond to half of a resonant period determined by the first conversion capacitor and the leakage inductor of the coupled inductor, so as to control the first conversion capacitor and the coupled inductor to perform a resonant operation for power conversion.

3. The multi-phase converter circuit of claim 1, wherein each of the at least one two-phase converter circuits comprises:
a first high-side switch coupled between the first conversion terminal and a first shunting node;
the first conversion capacitor coupled between the first shunting node and a first switching node;
a first low-side switch coupled between the first switching node and a ground potential;
the first inductor coupled between the first switching node and the second conversion terminal;
a second high-side switch coupled between the first shunting node and a second switching node;
a second low-side switch coupled between the second switching node and the ground potential; and
the second inductor coupled between the second switching node and the second conversion terminal;
wherein, in the charging phase, the first high-side switch is turned ON to control the first conversion capacitor and the first inductor to be electrically connected in series between the first and second conversion terminals;
wherein, in the discharging phase, the first low-side switch and the second high-side switch are turned ON to control the first conversion capacitor and the second inductor to be electrically connected in series between the ground potential and the second conversion terminal.

4. The multi-phase converter circuit of claim 1, wherein the at least one two-phase converter circuit comprises sequentially arranged first to Qth two-phase converter circuits, wherein Q is greater than 1, and each of the first to the Qth two-phase converter circuits has a first conversion terminal coupled to the first voltage, and has a second conversion terminal coupled to the second voltage;
wherein, among any two adjacent two-phase converter circuits, corresponding switches are configured to switch in inverted phase to each other.

5. The multi-phase converter circuit of claim 3, wherein each of the at least one two-phase converter circuits further comprises:
an auxiliary switched-capacitor converter circuit, comprising an auxiliary capacitor, a first auxiliary switch, and a second auxiliary switch;
wherein the first auxiliary switch is coupled between the first conversion terminal and an auxiliary shunting node, the second auxiliary switch is coupled between the auxiliary shunting node and the first switching node, and the auxiliary capacitor is coupled between the auxiliary shunting node and the second switching node;
wherein, in the charging phase, the second auxiliary switch is turned ON to control the auxiliary capacitor and the first inductor to be electrically connected in series between the ground potential and the second conversion terminal, to control the first conversion capacitor and the first inductor to be electrically connected in series between the first conversion terminal and the second conversion terminal, and to allow the second inductor to be electrically connected between the ground potential and the second conversion terminal;
wherein, in the discharging phase, the first auxiliary switch is turned ON to control the auxiliary capacitor and the second inductor to be electrically connected in series between the first conversion terminal and the second conversion terminal, to control the first conversion capacitor and the second inductor to be electrically connected in series between the ground potential and the second conversion terminal, and to control the first inductor to be electrically connected between the ground potential and the first conversion terminal.

6. The multi-phase converter circuit of claim 3, wherein the at least one two-phase converter circuit comprises sequentially arranged first to Mth two-phase converter circuits, wherein M is greater than or equal to 2;
wherein a first conversion terminal of a kth two-phase converter circuit is coupled to a second shunting node of a (k−1)th two-phase converter circuit, and a second conversion terminal of the kth two-phase converter circuit is coupled to the second voltage, where k=2 to M;
wherein each of the first to (M−1)th two-phase converter circuits further comprises a second conversion capacitor coupled between the second high-side switch and the second switching node, and the second high-side switch and the second conversion capacitor are jointly coupled to the corresponding second shunting node;
wherein the switches of the first to Mth two-phase converter circuits are configured to switch in phase with each other.

7. The multi-phase converter circuit of claim 6, wherein a capacitance of the second conversion capacitor is significantly greater than a capacitance of the first conversion capacitor, such that the second conversion capacitor does not participate in a resonant operation, and only the first conversion capacitor and either the first inductor or the second inductor perform the resonant operation.

8. The multi-phase converter circuit of claim 6, further comprising an auxiliary switched-inductor converter circuit, wherein the auxiliary switched-inductor converter circuit comprises:
an auxiliary high-side switch coupled between a second shunting node of the Mth two-phase converter circuit and an auxiliary switching node;
an auxiliary low-side switch coupled between the auxiliary switching node and a ground potential; and
an auxiliary inductor coupled between the auxiliary switching node and the second voltage;
wherein the auxiliary high-side switch is further turned ON during a charging phase to control the auxiliary inductor to be electrically connected between the second shunting node of the Mth two-phase converter circuit and the second voltage, thereby generating an auxiliary inductor current flowing through the auxiliary inductor.

9. The multi-phase converter circuit of claim 3,
wherein the first two-phase converter circuit further comprises a second conversion capacitor coupled between a second high-side switch and a second switching node, the second high-side switch and the second conversion capacitor being jointly coupled to a second shunting node;
wherein the multi-phase converter circuit further comprises an auxiliary switched-inductor converter circuit, the auxiliary switched-inductor converter circuit comprising:
an auxiliary high-side switch coupled between the second shunting node of the first two-phase converter circuit and an auxiliary switching node;
an auxiliary low-side switch coupled between the auxiliary switching node and a ground potential; and
an auxiliary inductor coupled between the auxiliary switching node and the second voltage;
wherein the auxiliary high-side switch is further turned ON during a charging phase to control the auxiliary inductor to be electrically connected between the second shunting node of the first two-phase converter circuit and the second voltage, thereby generating an auxiliary inductor current flowing through the auxiliary inductor.

10. The multi-phase converter circuit of claim 1, wherein the first inductor and the second inductor have the same number of turns.

11. The multi-phase converter circuit of claim 1, wherein the plurality of electrical connection states further optionally includes a freewheeling phase, in which the plurality of switches control the first inductor and the second inductor to be electrically connected between a ground potential and the second conversion terminal, thereby demagnetizing the first inductor and the second inductor.

12. The multi-phase converter circuit of claim 1, wherein, during a charging phase, when a first inductor current flowing through the first inductor decreases below a predetermined zero-current threshold, a transition to a discharging phase is performed; or, during a discharging phase, when a second inductor current flowing through the second inductor decreases below the predetermined zero-current threshold, a transition to a charging phase is performed, thereby achieving zero-current switching (ZCS) or zero-voltage switching (ZVS).

13. The multi-phase converter circuit of claim 12, wherein, at a timing when the charging phase transitions to the discharging phase, the first inductor current is greater than the second inductor current, and a difference between the first inductor current and the second inductor current corresponds to a magnetizing current; and wherein, at a timing when the discharging phase transitions to the charging phase, the second inductor current is greater than the first inductor current, and a difference between the second inductor current and the first inductor current corresponds to the magnetizing current.

14. The multi-phase converter circuit of claim 13, wherein a dead time is included during a phase transition between the charging phase and the discharging phase, and the magnetizing current is used during the dead time to achieve zero-voltage switching (ZVS) of the first high-side switch and/or the second high-side switch.

15. The multi-phase converter circuit of claim 4, wherein, at a steady state, a DC component of a voltage across the first conversion capacitor of each of the first to Qth two-phase converter circuits is 1/N of the first voltage, and a voltage conversion ratio between the first voltage and the second voltage is 2N:1, where N is a positive integer greater than or equal to 2.

16. The multi-phase converter circuit of claim 6, wherein, at a steady state, a DC component of a voltage across the first conversion capacitor of each of the first to k′th two-phase converter circuits is (2M−(2k′−1))/2M of the first voltage, and a DC component of a voltage across the second conversion capacitor of each of the first to k′th two-phase converter circuits is (2M−2k′)/2M of the first voltage, where k′=1 to M, and a voltage conversion ratio between the first voltage and the second voltage is 2M·2:1.

17. The multi-phase converter circuit of claim 8, wherein, at a steady state, a DC component of a voltage across the first conversion capacitor of each of the first to k′th two-phase converter circuits is ((2M+1)−(2k′−1))/(2M+1) of the first voltage, and a DC component of a voltage across the second conversion capacitor of each of the first to k′th two-phase converter circuits is ((2M+1)−2k′)/(2M+1) of the first voltage, where k′=1 to M, and a voltage conversion ratio between the first voltage and the second voltage is (2M+1)·2:1.

18. The multi-phase converter circuit of claim 1, wherein a ratio between the second voltage and the first voltage is adjusted by controlling a duty cycle and/or a switching frequency of the charging phase and/or the discharging phase.

19. The multi-phase converter circuit of claim 1, wherein the two-phase converter circuit comprises a first current sensing circuit and a second current sensing circuit, which are respectively coupled in parallel to the first inductor and the second inductor, and configured to generate a first current sensing signal and a second current sensing signal respectively indicating the first inductor current and the second inductor current, wherein the first current sensing circuit and the second current sensing circuit respectively comprise a sensing resistor and a sensing capacitor.

20. The multi-phase converter circuit of claim 1, wherein, during a resonant operation, the first conversion capacitor undergoes net charging during the charging phase and net discharging during the discharging phase.
